(19) United States
(12) Patent Application Publication
(10) Pub. No.: US 2006/0171173 A1
(43) Pub. Date: Aug. 3, 2006

(54) Light holder system

(76) Inventors: Jared Hendricks, Draper, UT (US); Erik Bornemeier, Bountiful, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/049,314

(22) Filed: Feb. 2, 2005

(51) Int. Cl. F21L 4/00

(52) U.S. Cl. 362/644; 362/656

(57) ABSTRACT

The present invention relates to an improved light holder system. The light holder system may be used individually or part of a light string. The light holder system includes a light bulb assembly and a light holder. The light bulb assembly is configured to securely releasably couple to the light holder in a manner to minimize undesired release. The light bulb assembly includes two elongated members that are configured to extend down through the light holder. At the ends of each elongated member is a locking flange that is configured to bias in a locked position when extended below the bottom of the light holder. In order to release the light bulb assembly, a user must compress both locking flanges and pull the light bulb assembly away from the light holder. In addition, the light bulb assembly includes a durable light bulb resistant to fracture.

### BACKGROUND

1. Field of the Invention

The present invention relates to a light holder system. More particularly, the present invention relates to a durable light bulb assembly configured to securely releasably couple to a light holder, maintain or increase illumination, and minimize light string vandalism.

2. Related Applications

This application claims priority to U.S. provisional application Ser. No. 60/543,485, filed Feb. 4, 2004.

3. Background of the Invention and Related Art

Decorative lights are commonly attached to structures to provide light and attract attention. During the winter holiday season, it is customary to attache strings of lights to residential and commercial buildings. These strings of lights are essentially light holders coupled in series to provide electricity to each light holder. Each light holder is configured to electrically and mechanically receive a particularly sized light bulb. The light bulbs may be white or colored depending on the application. In addition, various electrical devices can be used to create lighting effects including blinking, strobing, flashing etc.

One of the problems associated with light holders used in most light strings is their fragile electrical and mechanical connection system. It is generally very easy to simply pull out a light bulb thereby causing an entire light string to turn off. This becomes very tempting for vandals who can render an entire light system inoperable by simply removing a single bulb. In addition to vandalism, individual light bulbs may inadvertently release from the light string when brushed against a surface.

Another problem with typical light string associated light holders is the shape of the light bulb tends to have a pointed tip. This tip is vulnerable to breaking when contacting surfaces. In addition, the tip may poke an individual suspending the lights from a particular structure.

Therefore, there is a need in the industry for a light bulb assembly and light bulb holder system that is durable and minimizes the risk of undesired release.

### SUMMARY OF THE INVENTION

The present invention relates to an improved light holder system. The light holder system may be used individually or part of a light string. The light holder system includes a light bulb assembly and a light holder. The light bulb assembly is configured to securely releasably couple to the light holder in a manner to minimize undesired release. The light bulb assembly includes two elongated members that are configured to extend down through the light holder. At the ends of each elongated member is a locking flange that is configured to bias in a locked position when extended below the bottom of the light holder. In order to release the light bulb assembly, a user must compress both locking flanges and pull the light bulb assembly away from the light holder. In addition, the light bulb assembly includes a durable light bulb resistant to fracture.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a perspective view of a light holder system in accordance with one embodiment of the present invention;

FIG. 2A illustrates a top view of the light bulb assembly illustrated in FIG. 1;

FIG. 2B illustrates a profile view of the light bulb assembly illustrated in FIG. 1;

FIG. 2C illustrates a second profile view of the light bulb assembly illustrated in FIG. 1; and

FIG. 2D illustrates a perspective view of the light bulb assembly illustrated in FIG. 1.

### DETAILED DESCRIPTION OF THE PREFERRED EMBODIMENTS

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention relates to an improved light holder system. The light holder system may be used individually or part of a light string. The light holder system includes a light bulb assembly and a light holder. The light bulb assembly is configured to securely releasably couple to the light holder in a manner to minimize undesired release. The light bulb assembly includes two elongated members that are configured to extend down through the light holder. At the ends of each elongated member is a locking flange that is configured to bias in a locked position when extended below the bottom of the light holder. In order to release the light bulb assembly, a user must compress both locking flanges and pull the light bulb assembly away from the light holder. In addition, the light bulb assembly includes a durable light bulb resistant to fracture. While embodiments of the present invention are directed at methods of acquiring advertising data and optimizing advertisements, it will be appreciated that the teachings of the present invention are applicable to other areas.

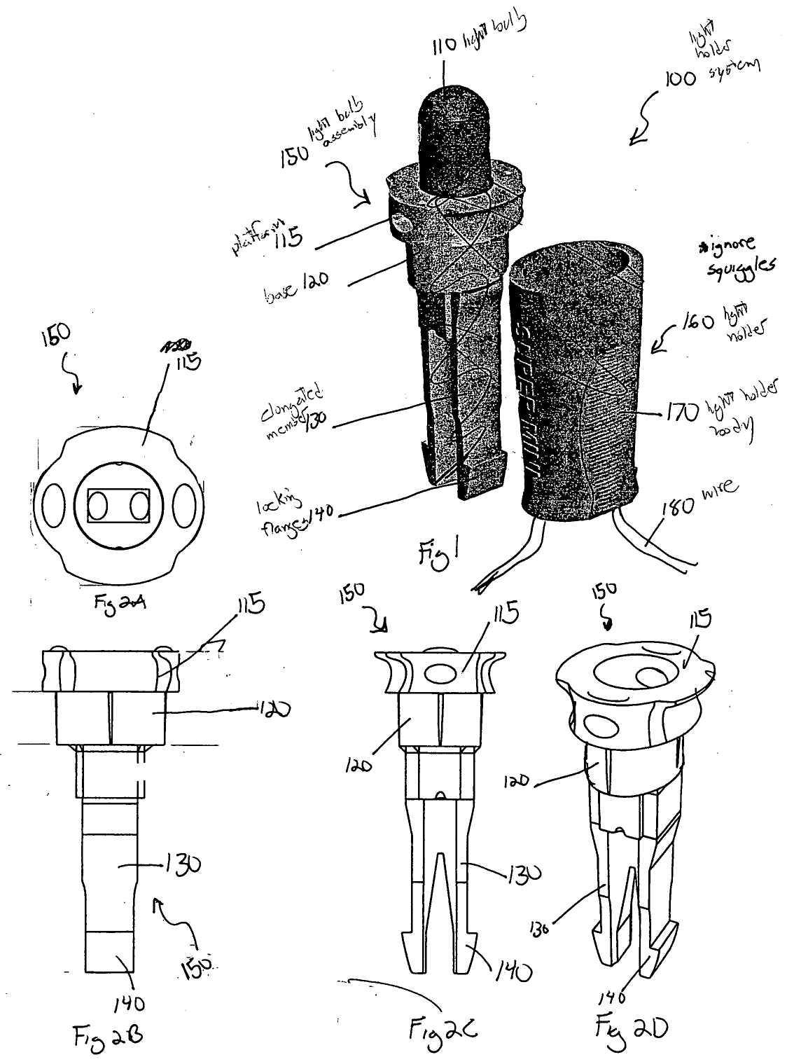

Reference is initially made to FIG. 1, which illustrates a perspective view of a light holder system in accordance with one embodiment of the present invention. The light holder system is designated generally at 100 and includes a light bulb assembly 150 and a light holder 160. The light holder 160 includes a base 170 which is shaped substantially cylindrically with a recess that extends through. The light holder 160 also includes two wires 180 which electrically couple the light holder 160 to an electrical power source and/or other light holders as part of a light string. An electrical coupling system (not shown) is disposed inside the recess to provide an electrical coupling between the light holder 160 and the light bulb assembly 150 when they are mechanically coupled.

Reference is next made to FIGS. 2A-2D which illustrate various views of the light bulb assembly illustrated in FIG. 1. The light bulb assembly 150 further includes a light bulb 110, a platform 115, a base 120, two elongated members 130, and two locking flanges 140. The light bulb 110 is composed of a dense glass composite such that it is resistant to fracturing. The light bulb 110 is also shaped as a lens to increase the illumination output. The platform 115 and base 120 provide a flat surface surrounding the light bulb 110 as shown. The shape of the platform 115 and base 120 are configured for the purpose of mechanically coupling with the light holder 160. For example, in the illustrated embodiment, the platform 115 has a diameter larger than the diameter of the recess on the light holder 160, therefore, the platform 115 will acts as a stop when the light bulb assembly 150 is inserted into the light holder 160.

The two elongated members 130 extend below the base 120 portion of the light bulb assembly 120, as shown. The two elongated members 130 are also sized in relation to the recess on the light holder 160, such that when the light bulb assembly 150 is properly inserted into the light holder 160, the two elongated members 130 provide a biasing force maintaining a releasable mechanical coupling between the light bulb assembly 150 and the light holder 160. Two locking flanges 140 are disposed on the ends of the elongated members 140. The location of the locking flanges 140 and the overall length of the elongated members 130 is configured such that the locking flanges 140 will extend below the light holder 160 when the light bulb assembly 150 is inserted into the light holder 160. The locking flanges 140 will be biased outward by the size of the recess in the light holder 160 and the spacing of the elongated members 130. The locking flanges 140 will therefore releasably lock or hook onto the bottom surface of the light holder 160 to provide a mechanical coupling between the light bulb assembly 150 and the light holder 160.

In operation, the light bulb assembly 150 is coupled to the light holder 160 by inserting the light bulb assembly 150 into the recess of the light holder 160, with the locking flanges 140 side of the light bulb assembly 150 being inserted first. The light bulb assembly 150 is then extended down through the light holder 160 such that the bottom of the elongated members 130 and the locking flanges 140 extend below the bottom surface of the light holder 160. The shape of the recess and the spacing of the elongated members 130 will then cause the locking flanges to hook onto the bottom surface of the light holder 160. An electrical coupling will automatically be engaged between the light holder 160 and the light bulb assembly 150 such that electrical current will be able to flow to the light bulb.

In operation, the light bulb assembly 150 is removed from the light holder 160 by performing the following acts. First, the two locking flanges 140 are compressed towards one another, thereby disengaging the hooking or locking between the light bulb assembly 150 and the light holder 160. Second, the bulb assembly 150 is retracted from the light holder 160. This process will automatically disengage the electrical coupling between the light bulb assembly 150 and the light holder 160.

It should be noted that various embodiments of coupling systems between the light bulb assembly 150 and the light holder 160 may be used and remain consistent with the present invention. For example, a single elongated member and locking flange would provide a coupling between the light bulb assembly 150 and the light holder 160. Naturally, other alternative embodiments have been contemplated and are consistent with this invention.

Thus, as discussed herein, the embodiments of the present invention relate to a light holder system. More particularly, the present invention relates to a durable light bulb assembly configured to securely releasably couple to a light holder, maintain or increase illumination, and minimize light string vandalism. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. A light holder system comprising:
a light holder including a recess;
a light bulb assembly including:
a light bulb;
at least one elongated member configured to extend down through the recess below the light holder; and
at least one locking flange disposed on a bottom portion of the at least one elongated member and configured to releasably secure the light bulb assembly to the light holder.

2. The light holder system of claim 1, wherein the at least one elongated member includes two opposing elongated members, and wherein the at least one locking flange includes two flanges disposed on the two opposing elongated members.

3. The light holder system of claim 1, wherein the at least one elongated member biases the two locking flanges in a locked configuration.

4. The light holder system of claim 1, wherein the light holder further includes at least one wire.

5. The light holder system of claim 1, wherein the recess on the light holder extends through the light holder.

6. The light holder system of claim 1, wherein the light bulb is shaped to act as a lens and increase the illumination output.

7. The light holder system of claim 1, wherein the light bulb is composed of a thick glass material.

8. The light holder system of claim 1, wherein the light holder system is part of a light string.

9. A light string comprising:
a plurality of lights comprising:
a light holder including a recess;
a light bulb assembly including:
a light bulb;
at least one elongated member configured to extend down through the recess below the light holder; and
at least one locking flange disposed on a bottom portion of the at least one elongated member and configured to releasably secure the light bulb assembly to the light holder;
an electrical system interconnecting the plurality of lights.

10. The light system of claim 9, wherein wherein the at least one elongated member includes two opposing elongated members, and wherein the at least one locking flange includes two flanges disposed on the two opposing elongated members.

11. The light holder system of claim 9, wherein the two elongated members bias the two locking flanges in a locked configuration.

12. The light holder system of claim 9, wherein the light holder further includes at least one wire.

13. The light holder system of claim 9, wherein the recess on the light holder extends through the light holder.

14. The light holder system of claim 9, wherein the light bulb is shaped to act as a lens and increase the illumination output.

15. The light holder system of claim 9, wherein the light bulb is composed of a thick glass material.

16. A method for coupling a light bulb assembly with a light holder comprising the acts of:
inserting the light bulb assembly into the light holder such that a portion of the light bulb assembly extends below the light holder; and
engaging a biased releasable coupling mechanism between the light bulb assembly and the light holder.

17. The method of claim 16 further including the act of engaging an electrical coupling mechanism such that electrical current can flow from the light holder to the light bulb assembly.

18. The method of claim 16, wherein the light holder and light bulb assembly are part of a light string.

19. A method for releasing a light bulb assembly from a light holder comprising the acts of:
compressing at least one locking flange on a bottom portion of the light bulb assembly that extends down below a bottom portion of the light holder; and
retracting the light bulb assembly out of the light holder.

20. The method of claim 19 further including the act of disengaging an electrical coupling mechanism between the light bulb assembly and the light holder.

21. The method of claim 19, wherein the light bulb assembly and the light holder are part of a light string.
